(19) United States
(12) Patent Application Publication
(10) Pub. No.: US 2026/0274630 A1
(43) Pub. Date: Sep. 17, 2026

(54) PALLET SHUTTLE CONTROL SYSTEMS

(71) Applicant: Spacemaker Systems, Inc., Ocoee, FL (US)

(72) Inventors: Paul Richard Bates, Randolph, NJ (US); Christof Botha, Pretoria (ZA); Mertin Coetzee, Gaunteng (ZA)

(73) Assignee: Spacemaker Systems, Inc., Ocoee, FL (US)

(21) Appl. No.: 19/562,198

(22) Filed: Mar. 10, 2026

Related U.S. Application Data
(60) Provisional application No. 63/770,230, filed on Mar. 11, 2025.

(51) Int. Cl. B66F 9/14; B66F 9/18; B65G 1/04

(52) U.S. Cl. CPC B66F 9/141; B66F 9/182; B65G 1/0435

(57) ABSTRACT

A pallet shuttle is provided for moving pallets along a tunnel in a storage rack. The pallet shuttle has magnets to prevent the pallet shuttle from falling off a fork lift vehicle as the pallet shuttle is being moved onto or off of a storage rack. The pallet shuttle also has distance measuring devices for precisely identifying the location of the pallet shuttle in the storage rack and/or in the tunnel of the storage rack to ensure that the pallet shuttle does not block areas that are required to remain open for fire safety purposes.

### CROSS-REFERENCE TO RELATED APPLICATION

This application claims the benefit of US Provisional Patent Application No. 63/770,230, filed March 11, 2025, the entire disclosure of which is incorporated herein by reference.

### BACKGROUND

### 1. Field of the Invention

The invention relates to a pallet shuttle control system for controlling a shuttle-based automated or semi-automated storage system, with particular emphasis on safety and efficiency.

### 2. Description of the Related Art

Most products are shipped from a manufacturer to a warehouse before being shipped to a store or to the ultimate consumer. The products are placed on pallets for storage at the warehouse and the pallets are placed on racks mounted in the warehouse. Forklift vehicles are used to lift and move the pallets in the warehouse. For simplicity, this disclosure will refer to forklift vehicles, but with the understanding that the term forklift vehicle encompasses other devices for moving pallets vertically and/or horizontally in a warehouse, including cranes, scissor lifts and the like. More particularly, a forklift vehicle has forks that can be positioned under a pallet. The forks then are lifted to elevate the pallet so that the forklift vehicle can move the pallet and the load on the pallet to an appropriate location in the warehouse. The forklift vehicle elevates the pallet to an appropriate height, advances the pallet onto the rack and then backs away from the rack that stores the pallet loaded with the stored goods. The forklift vehicle subsequently may retrieve the pallet from the rack and move the pallet to a different specified location in the warehouse, often for shipment of at least part of the load to a consumer. A loaded pallet often will weigh 2000 pounds or more.

The tremendous growth in on-line shopping and the frequent use of just-in-time delivery protocols used by many manufacturers has required warehouse systems to improve efficiency. Many warehouses currently use wheeled motorized shuttles that can store and move pallet loads of goods on the rack system. More particularly, a shuttle can be moved at least in forward or rearward directions along a tunnel of a rack system in the warehouse. The “tunnels” in a warehouse generally are not fully enclosed like a tunnel on a roadway. Rather, the storage tunnels of a warehouse typically are defined by an open grid-like framework. Plural storage tunnels typically will be arranged on a single level in the rack system, with the tunnels in the single level of the rack system being horizontally adjacent to one another and parallel. Plural storage tunnels also are arranged vertically above or below one another. Thus, each storage tunnel will be horizontally adjacent to at least one other tunnel and vertically adjacent at least one other tunnel. Most storage tunnels in a rack system will be horizontally adjacent to and between two other tunnels, and similarly will be vertically adjacent to and between two other tunnels.

A forklift vehicle generally is used to lift the shuttle to the height of a specified tunnel and then guides the shuttle into the tunnel. The properly positioned shuttle typically will stay in the tunnel for a considerable time. However, shuttles must be removed periodically for repair and maintenance and must be removed when the rack system of the warehouse is being repaired or reconfigured. A warehouse often will include hundreds of tunnels and may include hundreds of shuttles. However, some warehouses will have fewer shuttles than tunnels. Thus, movement of shuttles onto and off of the rack system by forklift vehicles is fairly common, particularly in a large warehouse and in a warehouse that has fewer shuttles than tunnels. However, it must be understood that shuttles are complicated costly devices that must be handled with care.

Forklift vehicles are used to lift a pallet load of goods and to position the pallet load of goods in the entrance of a particular tunnel of the rack system. The shuttle of that tunnel then moves the pallet and the goods thereon to a specified position along the tunnel of the rack system. The shuttle then may move a particular pallet to the entrance of the respective tunnel so that a forklift vehicle can remove the pallet load of goods from the entrance of a tunnel and move that pallet load of goods to another location in the warehouse.

Some shuttles and some rack systems are designed to move pallets in forward and rearward directions and also to move pallets horizontally in left and right directions that are transverse to the forward and rearward directions. Thus, a shuttle and the pallet stored thereon can be moved longitudinally in one tunnel and laterally into a storage space horizontally adjacent to the tunnel. Shuttles of this type generally have a first set of wheels for moving the shuttle longitudinally along the length of the tunnel and a second set of wheels to move the shuttle laterally transverse to the length of the tunnel.

A shuttle generally is narrower than the pallet so that opposite side regions of the pallet will overhang the shuttle. Similarly, each tunnel will have a narrow bottom channel that can accommodate longitudinal movement of the shuttle along the length of the bottom channel in the tunnel. The narrow bottom channel of each tunnel will have a depth that equals or exceeds the height of the shuttle. Parts of each tunnel laterally of the bottom channel define left and right rails that extend along the length of the tunnel. Pallets will be supported on the rails when the pallets are not being moved.

Each shuttle will have plural lifts that can be raised from the upper surface of the shuttle. The lifts can be actuated when the shuttle is positioned below the pallet and function to lift the pallet from the left and right rails of the tunnel. The shuttle then can move the pallet longitudinally along the tunnel. With some systems, the shuttle also can move the elevated pallet horizontally into left or right storage spaces that communicate with the tunnel.

A forklift vehicle will lift a pallet and move the lifted pallet into the entrance of a selected storage tunnel. The forklift vehicle then will lower the pallet onto the left and right rails that extend longitudinally along the length of the tunnel. The forklift vehicle then will move rearward away from the rack while leaving the deposited pallet on the pallet rails at the entrance of the tunnel. The forklift vehicle then is free to move in the warehouse to retrieve and position another pallet. The shuttle of the tunnel that has just received the pallet then moves into position below the pallet and lifts the pallet from the left and right pallet rails. The shuttle then moves the elevated pallet along the tunnel to a specified position away from the tunnel entrance. The reverse procedure is carried out to remove a pallet and its load from the rack system.

The above-described system of forklift vehicles, motorized pallets and rack systems can achieve a high degree of automation and efficiency. However, there is a continuing need for improved efficiency and safety.

One concern relates to the risk of a shuttle falling off the forks of a forklift truck before the shuttle is mounted properly in the entrance to a tunnel of the rack system or while the shuttle is being transported to or from a tunnel of the rack system. Shuttles are large, heavy, complicated and costly devices that must be handled with care. A shuttle that slides off the elevated forks of the forklift vehicle is likely to be destroyed while risking damage to the rack system and injury to workers. Motorized pallets with electromagnets have been in use commercially since at least as early as 2016. The electromagnets can be energized to hold the pallet on the forks of the forklift vehicle. Additionally, US Patent No. 10,589,929 discloses several options for securing a pallet to the forks of a forklift vehicle. These options include interengageable ribs, pegs or hooks on the pallet and on the forks, and high friction surfaces on the pallet and on the forks. Permanent magnets or electromagnets on the pallet or the forks also are disclosed. Manual switches provided on the forklift vehicle to activate the electromagnets create the risk of human error. Automated switches on the pallet and on the forks are subject to frequent contact during use and can be damaged. Permanent magnets are envisioned in US Patent No. 10,589,929 but require complex assemblies of wedges to generate forces that can separate the permanent magnets from an opposed ferrous metal structure.

Safety concerns also relate to the racks. The racks are subjected to heavy loads from the pallets and those loads can bias the rails in each tunnel away from one another. Sufficient movement can cause one or many shuttles to fall between the rails, thereby damaging the racks, the shuttles, the pallets and items stored in a lower storage tunnels. Currently, there is no mechanism for predicting or preventing such structural failures of the racks or the rails in a rack.

Safety concerns also can be caused by intentional but improper maintenance. In this regard, the motorized shuttles are powered by onboard electric batteries. Batteries periodically require replacement. Warehouse managers may consider cost savings by utilizing improper batteries. However, an improper battery can cause a fire or can damage the costly electric motors and controls of the shuttle.

Fire codes often require clear areas in warehouses for delivering water or fire retardants to extinguish a fire. These codes often specify that no pallets or shuttles be stored in areas that are intended to be devoted to a spraying of water or fire retardants. Mechanisms for ensuring that no pallets are stored in areas that are intended to be clear would be well received.

Storage and retrieval inefficiencies require warehouse operators to know where shuttles are located in the warehouse. However, efficient retrieval requires knowledge about the location of the shuttles. Shuttles move much more frequently than any particular pallet. Temporarily lost shuttles are not uncommon and often require manual efforts to locate the shuttles. Improvements are desired for tracking locations of shuttles.

### SUMMARY OF THE INVENTION

A first aspect of the invention relates to a motorized shuttle that can be used with the above-described warehouse rack system for selectively placing, storing and retrieving pallets that are or may be loaded with goods. Each shuttle has one or more electric motors used to rotate one or two sets of wheels that will enable the shuttle to move in plural directions in one or more storage tunnels in the above-described rack system of the warehouse. The shuttle also has at least one transceiver or other communication device that is configured to send and/or receive signals generated by a control unit in the warehouse and/or by a user interface, such as a handheld control device, for transmitting and receiving signals. For example, the control unit of the warehouse, the user interface and/or the transceiver on the shuttle can function to control the rotational direction and speed of motors that are mounted in the shuttle and that are operative to drive wheels for moving one of the shuttles in the warehouse to a selected location. The shuttle also may include plural sensors capable of determining which storage tunnel the shuttle is in and where along the storage tunnel the shuttle is positioned. The control unit of the warehouse comprises an electronic digital storage unit and an electronic digital processing unit. The processing unit is configured to read out and execute the instructions and methods described herein. The elements and functions described herein may be implemented in various forms of hardware, software or combinations thereof that may be coupled to one another. These elements may be implemented in a combination of hardware and software on one or more appropriately programmed general-purpose devices, which may include a processor, memory and input/output interfaces. The term "coupled" as used or implied herein means directly connected to or indirectly connected through one or more intermediate components. Such intermediate components may include both hardware and software-based components.

Sensors are provided on the motorized shuttle and on the rack system to sense the presence of the motorized shuttle on the rack system. A switch may connect the sensors to the electromagnets and keeps the electromagnets in a de-activated state as long as the sensor detects that the motorized shuttle is on or very close to the rails of the storage tunnel. However, the switch is activated when the sensor determines that the motorized shuttle is no longer on the rails. The shuttle will no longer be on the rails when the shuttle has been lifted by a forklift vehicle. As a result, the sensor will trigger the switch and cause the electromagnet to be activated as soon as the contact or proximity between the shuttle and the rail has been terminated. The activated electromagnets of the shuttle are positioned to align with the forks of the forklift vehicle and will hold the shuttle on the forklift vehicle until the shuttle has been repositioned onto another location in the rack system. This arrangement avoids the possibility of human error occurring with switches that must be activated by a forklift operator to magnetically attach the shuttle to the forklift vehicle. The sensors can be end of rail sensors that determine whether the shuttle is still on the rails of the rack.

Permanent magnets avoid problems associated with a failure of the electromagnet due to a power loss or circuit damage. The permanent magnets considered in the prior art relied upon complex assemblies of wedges to separate the pallet from the forklift vehicle. However, certain embodiments of the system disclosed herein are provided with hydraulic switches or levers that are moved as the shuttle is being placed on or removed from the rails. These configurations avoid the risk of failure of the electromagnets due to lost power or circuit damage. Additionally, the hydraulic switches or levers can be operated in extreme temperatures or in wet conditions without risk of failure.

In some embodiments, the motorized shuttle includes an absolute encoder, or rotary encoder for accurately identifying the position of the shuttle. A rotary encoder assigns a unique and precise digital value to each angular rotational position. For example, a rotary encoder with 16-bit resolution will have 65,536 unique positions. Importantly, the rotary encoder retains position data even when powered off. Accordingly, the rotary encoder that is incorporated into the shuttle tracks the exact location of the shuttle along the rails based on the point where the encoder was zeroed. The rotary encoder communicates via protocols, such as SSI or CANopen to the PLC for real-time adjustments. The rotary encoder avoids cumulative errors that can occur with incremental encoders that lose position data after power cycles. Rotary encoders provide repeatable accuracy in high-density storage systems.

An absolute encoder can be paired with rack-mounted reference markers, such as magnetic strips or optical tags to cross-verify positions of the shuttle to which the encoder is mounted. The combination of absolute encoders with rack-mounted reference markers can ensure that shuttles are placed within plus or minus 10mm tolerance by comparing encoder data to predefined rack coordinates. Additionally, these absolute encoders automatically correct for drift caused by wheel slippage or wear. This arrangement also ensures that pallets are not mistakenly positioned where they could block a fire suppression system from working correctly.

Laser measurement systems also can be used for accurately tracking the positions of all pallets or shuttles in a rack storage system. For example, a time-of-flight (ToF) laser system emits pulsed light to measure the distance to a target location. A laser emitted from the pallet or shuttle can determine a distance from the shuttle to the end of the rack to calculate the position and alignment of the shuttle or pallet. This arrangement ensures that pallets will not be placed inadvertently at a location that could block fire suppression systems from working properly.

Accurate positioning of the pallet can be determined by RFID tags embedded in the rails or beams of a rack system and can be paired with a reader on the shuttle. Thus, the shuttle reads the tag IDs to determine the location of the shuttle or pallet along the rack. Tags also can store data such as pallet type, weight limit or battery storage. These systems can prevent incorrect pallet retrieval or placement in mixed-SKU environments and reduces manual scanning labor.

Accurate positioning of the pallet or shuttle also can be monitored and determined by using barcode or QR codes printed or mounted on the rack. These codes can be scanned by a shuttle-mounted camera or laser scanner to provide a low-cost location verification. With these embodiments, the shuttle must pause briefly (less than one second) for line-of-site scanning. As with the previously described embodiments, this optional use of barcode or QR codes in combination with shuttle-mounted cameras or laser scanners accurately prevents having a misplaced pallet or shuttle block the fire suppression system of a warehouse.

Each pallet or shuttle in a warehouse preferably has a dedicated home position at a predefined distance from the ends of the rails. In some embodiments, an RFID tag is positioned at the home location of a shuttle. The controller of the warehouse system re-calibrates the shuttle’s position after completing tasks or during error recovery. The system also updates the encoder’s zero point to counteract mechanical wear. A warehouse system with these features prevents progressive misalignment over time, which could lead to system-wide positioning errors. As an alternative to the RFID tags, barcodes or QR codes can be provided at the home location of the shuttle, which is a predefined distance from the end of the rail. This arrangement offers a simple reference for operators to manually park or recalibrate the shuttle.

A mechanical measurement device also can be used in some embodiments for home position determination. For example, a mechanical limit switch or an optical beam sensor can detect the home position. Such a switch physically triggers when the shuttle contacts the switch, thereby providing a failsafe reference. A system that relies upon in mechanical limit switch avoids complete loss of positioning data due to encoder or software faults.

A LiDAR sensor or a radar sensor can be used for anti-collision purposes. For example, a LiDAR sensor or radar sensor can be mounted in the front and/or rear of the shuttle to identify obstacles in the path of the shuttle and to immediately brake the shuttle, thereby avoiding damage to the shuttle or material stored on a pallet that is being transported in the tunnel by the shuttle.

Batteries of motorized pallets or shuttles must be replaced periodically. An attempt to replace a battery with a battery other than one specified by the manufacturer can damage controls or motors and, in some situations, can cause a fire. To prevent these problems, the controller of some embodiments is programmed to perform a digital handshake with a new battery before the motorized pallet or shuttle can be operated with a new battery. This simple provision can prevent damage to the controller, the motor or the entire shuttle.

Infrared or ultrasonic sensors may be mounted on sides of the shuttle and may be angled toward the rack structure. The infrared or ultrasonic sensors measure gaps between the shuttle and the rack. These measurements will detect whether parts of the rack system may be deformed into a shape that could damage a shuttle or cause a pallet to fall from one level to another. Thus, corrections and repairs to the rack system can be made before causing costly damage to the warehouse and the stored material.

The shuttle may be provided with a printed circuit board that has block converters, fuses and MOSFETs to route power to sensors and controllers that are part of the shuttle. These configurations isolate noise-sensitive components and provide a connection interface to remove the need for crimped or soldered wiring. Thus, the voltage spikes that may damage electronics are prevented, as are intermittent sensor failures.

The shuttle may have a belt-driven drive train. More particularly, a synchronous rubber drive train may connect the wheels of the shuttle to the gearbox that is associated with the motor. This drive train absorbs shocks from uneven floors and reduces wear on gears. Gear tooth sheer is avoided while providing a quieter drive system than conventional chain drives.

Some embodiments may have solid steel shafts with universal joints to transfer motor torque to the wheels of the shuttle. This configuration can handle heavier loads with minimal power loss while preventing belt slippage in high torque applications and ensuring precise starts and stops of the drive train.

The shuttle may comprise four separate motors provided respectively for each of the four wheels of the drive train. This configuration enables load balancing with torque vectoring to adjust power at each of the wheels when the surface is determined to be slippery.

The shuttle may have an electric ball-screw actuator for lifting the pallet. The ball-screw actuator achieves smooth lifting of the pallet with potential feedback from a built-in potentiometer or encoder. This configuration avoids jerky lifting movements that could destabilize fragile loads.

A laser distance sensor may be provided for height measurements. The laser sensor measures the gap between the platform and the chassis to determine if the lifting platform is in the top or bottom position. This configuration ensures that the lifting mechanism will not provide over-rotating or under-rotating by ensuring an exact platform height.

A rotary encoder may be provided on the actuator motor shaft for tracking rotations. The rotary encoder converts motor rotations into linear height of the platform and reduces dependency on external sensors, thereby reducing component costs.

Suction cups may be provided for securing the shuttle to the forks of the forklift truck. This configuration avoids scratches or dents that could otherwise be caused by magnets on the delicate fork surfaces. The suction cups generate a vacuum seal that will hold a loaded pallet on the forks and are useful where nonmagnetic components are used.

Photoelectric sensors may be arranged across the platform of the shuttle on which a pallet is placed. The sensors detect pallet edges and trigger adjustable side clamps. The sensor array prevents partial pallet engagement or off-center pallet engagement on the lifting platform and prevents drops that otherwise might occur during acceleration of the shuttle.

The shuttle may have or may communicate with measuring devices for measuring the length and width dimensions of a pallet that is positioned on the shuttle. The measuring apparatus may use the pallet-in-place sensor as a reference to start measuring distance. This configuration allows the shuttle to pick up shorter pallets than the length of the lifting platform of the shuttle.

Load cells may be provided on the shuttle to detect weight of the pallet. For example, four strain-gauge load cells may be provided respectively under corners of the platform of the shuttle on which the pallet is placed. The load cells may trigger alarms if the load of the pallet reaches or approaches the maximum capacity of the shuttle. This configuration avoids overloading the shuttle and further avoids strain on the motors and on the racks.

Grip tape, such as diamond-grade adhesive tape may be provided on the lifting surface of the shuttle to reduce possibility of pallets slipping on the lifting platform of the shuttle. This configuration avoids shifts, such as those that occurred during high-speed directional changes of movement of the shuttle, for example from longitudinal movement to lateral movement.

Reinforcement members may be positioned across the platform of the shuttle to prevent having overhanging parts of a pallet sag at positions that project beyond the sides of the shuttle.

Spring-loaded or gravity operated pins may pop up through the platform of the shuttle to block pallet movement during transit. These pins then retract to be flush with the upper surface of the platform when the shuttle is not in use. The elevated pins prevent load shifts during abrupt stops or on inclines.

Sonar sensors may be provided for pallet detection. For example, ultrasonic sensors may emit sound waves to detect the presence of a pallet on the platform of the shuttle. These ultrasonic sensors function in dusty environments where optical sensors fail and avoid false “pallet missing” errors in dirty or humid conditions.

A cable extension transducer with a stainless-steel cable may be provided to measure platform height by tracking the cable extension. This measurement technique is immune to motor slippage.

A multi--gateway-mesh RF network may be provided to allow communication between the pallet shuttles and controlling devices. More particularly, this arrangement allows communications between devices on an encrypted network without the need for connection events. Devices can join and leave the network if there is the correct encryption. The system collects data on all activities on the network as well as data on all actions performed by the pallet shuttles. Additionally, the system prevents unauthorized entities from controlling the shuttles as well as ensuring connectivity in the rack structure. A database tool may be provided to interpret the data collected by the MGM. The collected data can be used to measure the performance of the shuttle system as well as overall efficiency of the system. The MGM server functions as a webpage that allows an operator to use a tablet or smart phone to connect to the pallet shuttle and to control the system without the need of a dedicated handheld controller.

The above-described aspects of the invention will become more apparent in the following detailed description and the accompanying drawings.

### BRIEF DESCRIPTION OF THE DRAWINGS

FIG. 1 is a perspective view of a forklift vehicle in accordance with an embodiment of the invention.

FIG. 2 is a perspective view of a shuttle in accordance with an embodiment of the invention.

FIG. 3 is an exploded perspective view of the shuttle of FIG. 2 with the top cover removed to show the electrical and mechanical components described herein.

FIG. 4 is a top plan view of the shuttle with the cover removed

FIG. 5 is a schematic top view of a motorized shuttle that incorporates electromagnets and a sensor to sense a relative position with respect to a rail of the storage tunnel, wherein the electromagnets are deactivated since at least one of the rail detectors sensors is still in the rack.

FIG. 6 is a schematic side elevational view of the storage tunnel and sensor shown in FIG. 5.

FIG. 7 is a schematic top view similar to FIG. 5 but with the shuttle elevated above the rail by a forklift vehicle.

FIG. 8 is a schematic side elevational view of the shuttle of FIG. 7 and shows the shuttle elevated above the rail, thereby resulting in the electromagnets being activated.

FIG. 9 is a schematic top view that shows an absolute encoder for indicating the exact location of the shuttle along the storage tunnel.

FIG. 10 is a schematic top view similar to FIG. 9 but showing the absolute encoder used for pallet placement.

FIG. 11 is a schematic top view showing laser measurement apparatus for pallet placement in a storage tunnel.

FIG. 12 is a schematic top view showing a shuttle that uses RFID tags for pallet positioning in a storage tunnel.

FIG. 13 is a schematic top view that shows the use of barcode or QR codes for pallet positioning in a storage tunnel.

FIG. 14 is a schematic top view that shows the use of an RFID to position a shuttle at a home position in a storage tunnel

FIG. 15 is a schematic top view showing the use of barcodes or QR codes for positioning a pallet at a home position in a storage tunnel.

FIG. 16 is a schematic top view that shows a mechanical limit switch or optical beam sensor to detect the home position of a shuttle.

FIG. 17 is a schematic top view showing a LiDAR on a shuttle for collision avoidance purposes within the storage tunnel.

FIG. 18 is a schematic side elevational view of the system shown in FIG. 16.

FIG. 19 is a schematic top view showing a RADAR on a shuttle for collision avoidance purposes within the storage tunnel.

FIG. 20 is a schematic side elevational view of the system shown in FIG. 19

### DETAILED DESCRIPTION

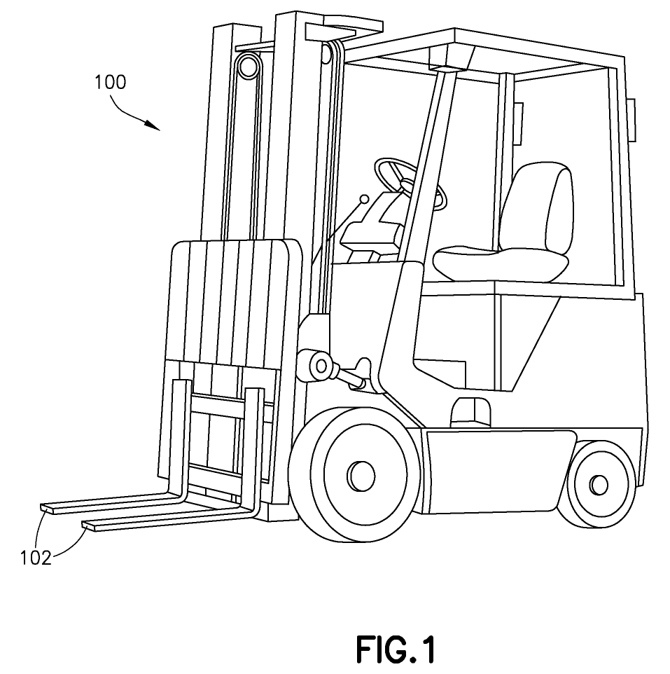

FIG. 1 shows a forklift vehicle 100 with two forks 102 that can be raised and lowered by controls on the forklift vehicle 100. The forks 102 of the forklift vehicle 100 can be used to lift a pallet loaded with goods and to place the pallet on a rack of a warehouse. The forks 102 of the forklift vehicle 100 also can be used to lift a shuttle, as described and illustrated herein, so that the shuttle can move the pallet on the rack.

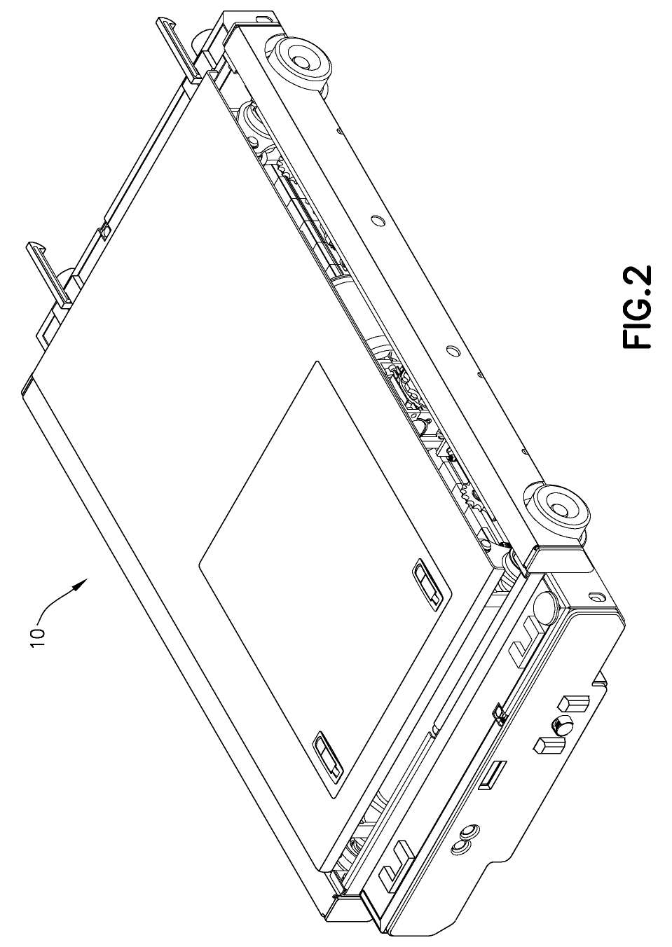

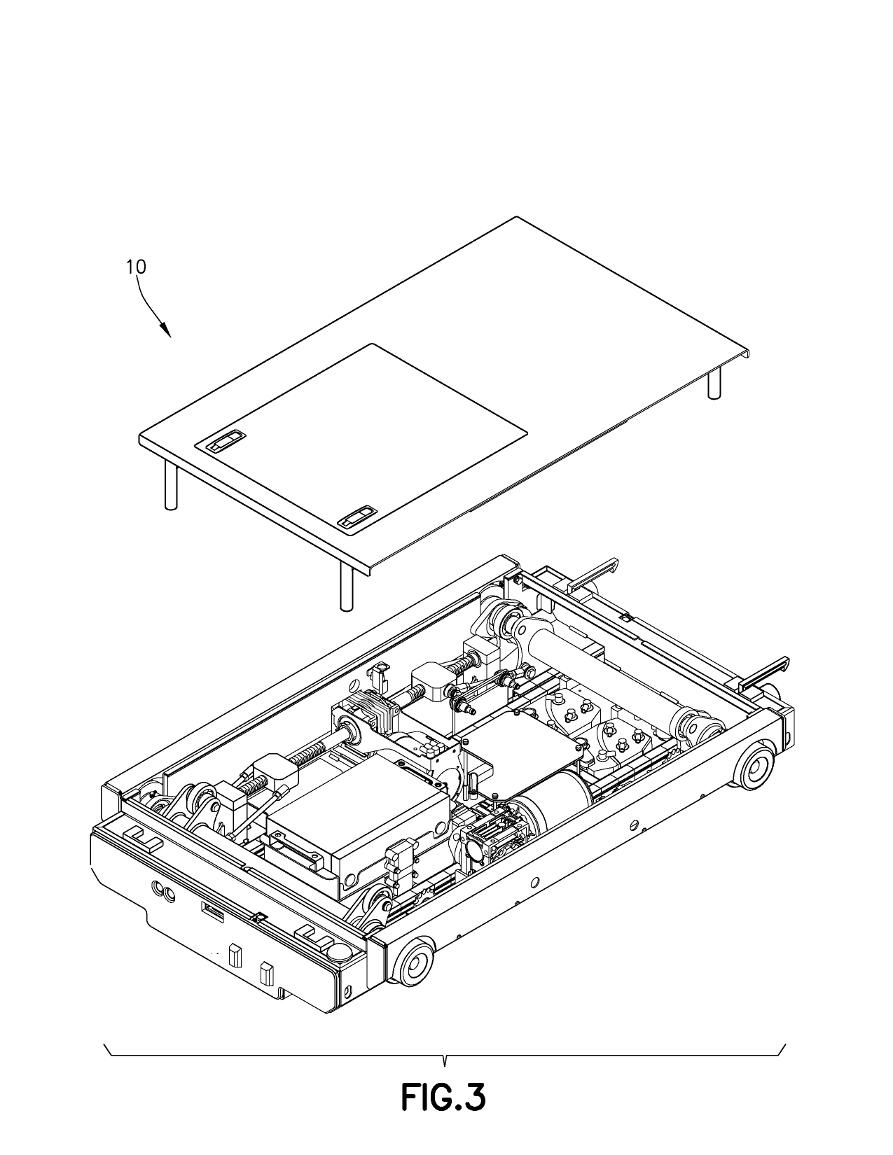

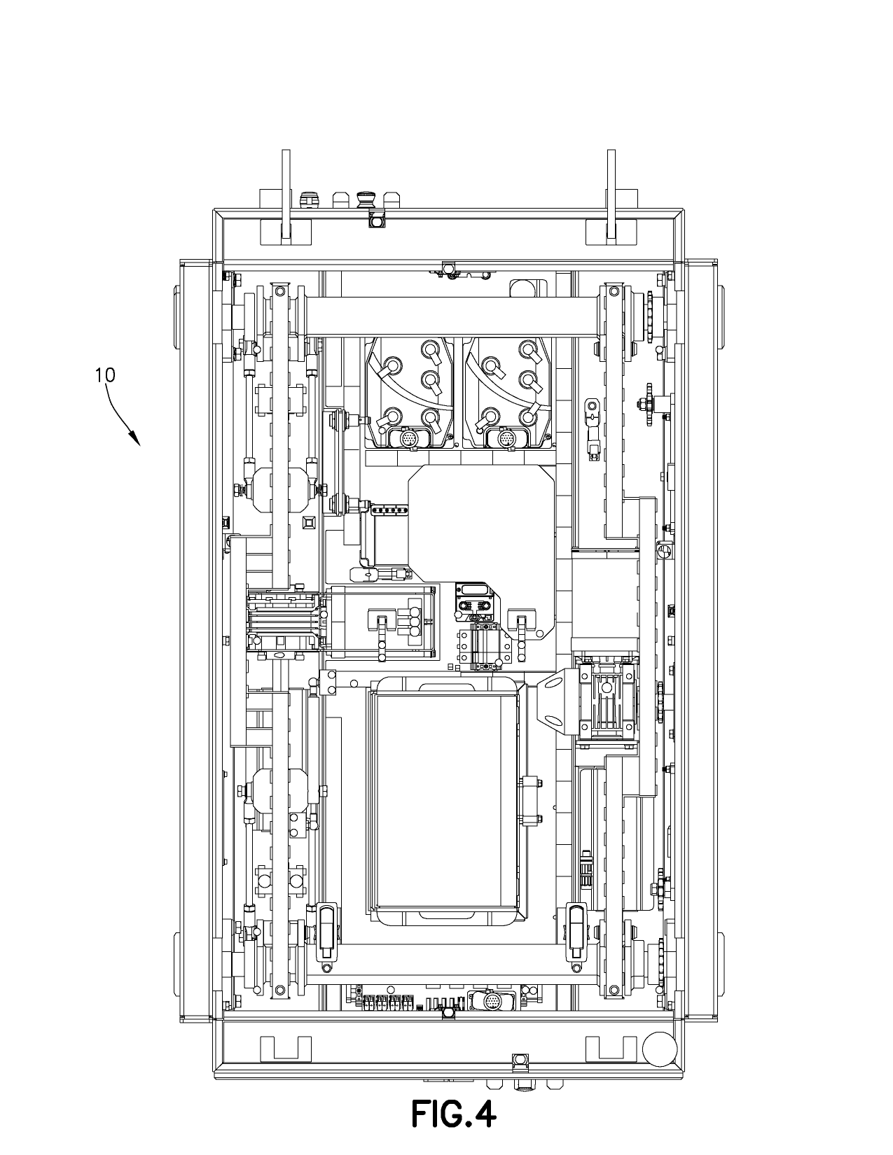

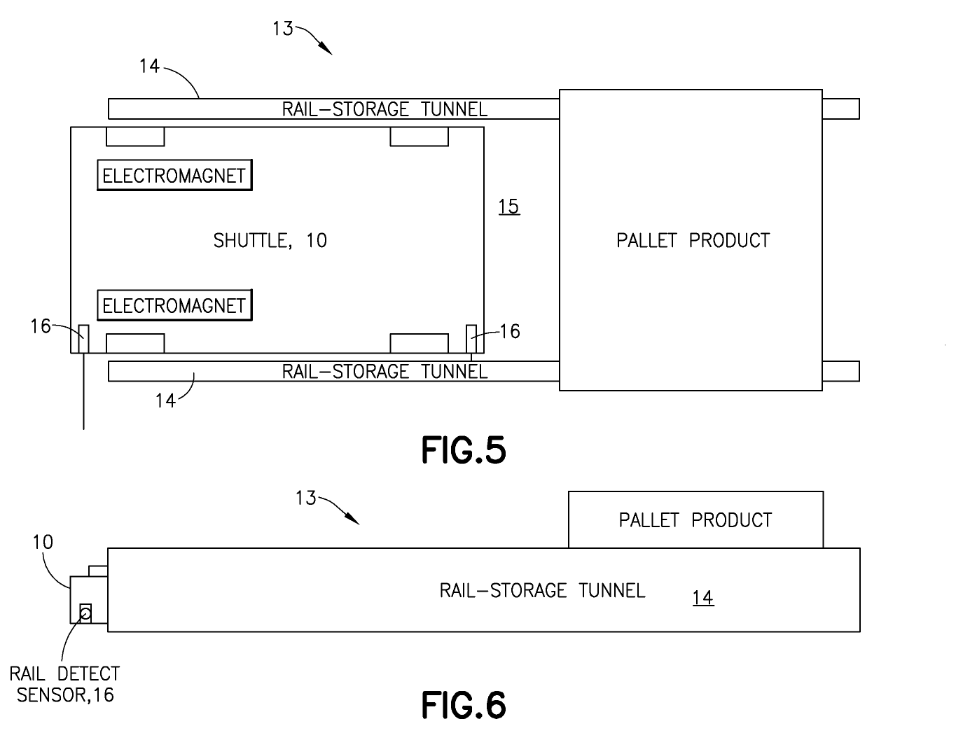

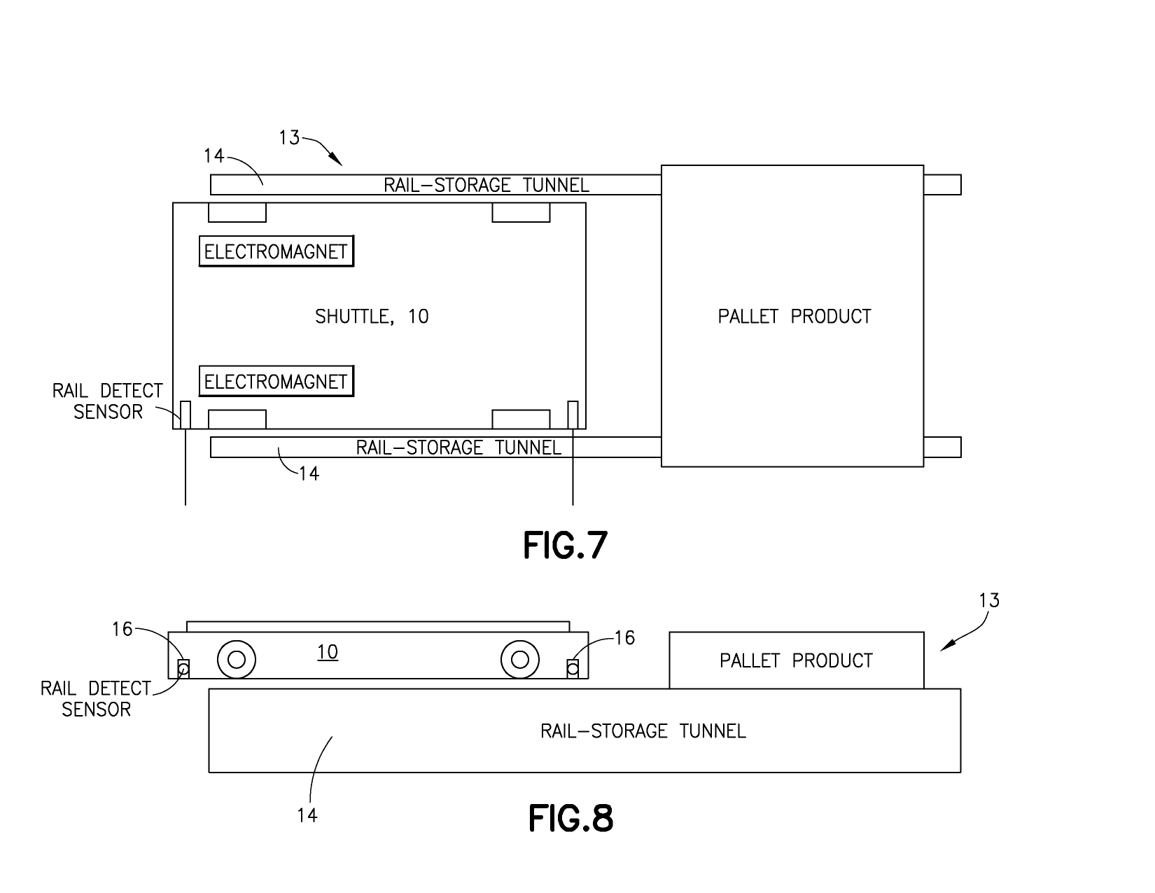

A motorized shuttle in accordance with an embodiment of the invention is identified generally by the numeral 10 in FIGS. 2-4. The shuttle 10 has electromagnets 12 incorporated therein. As shown in FIGS. 5 and 6, the shuttle 10 is in a relatively low position in a tunnel 13 of a rack system and is seated on a horizontal support surface 15 between two rails 14. FIGS. 7 and 8 show the shuttle 10 in an elevated position and spaced above the rails 14, as is evident by comparing FIGS. 6 and 8. The shuttle 10 would get into the position shown in FIG. 8 by being lifted by the forks of a forklift vehicle 100. This upward movement of the shuttle 10 is sensed by the sensor 16 and generates a signal for activating the electromagnets 12. Thus, the electromagnets 12 securely affix the shuttle 10 to the forks of the forklift vehicle 100 as the shuttle 10 is being transported in the warehouse from one storage tunnel 13 to another.

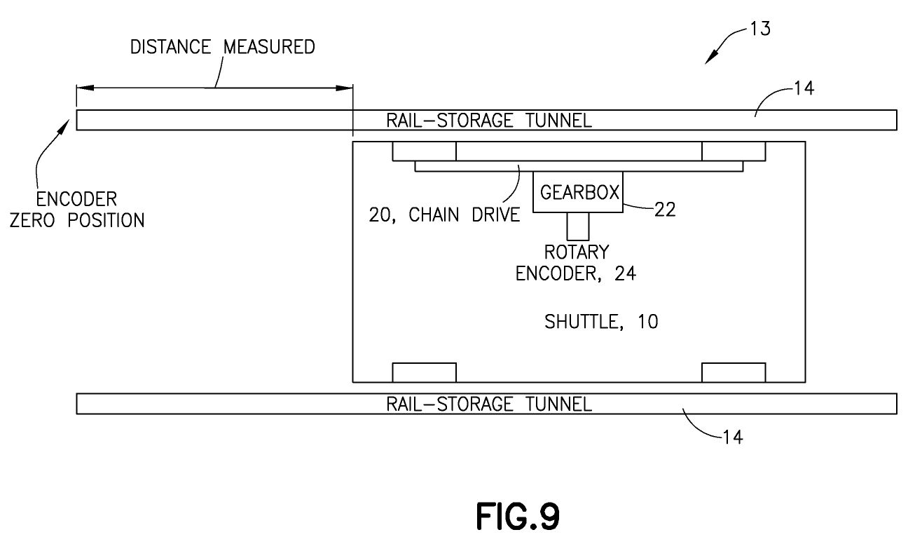

FIG. 9 shows a shuttle 10 that uses a chain drive 20, a gearbox 22 and an absolute rotary encoder 24 for determining the exact location of the shuttle 10 along the rails 13. The absolute rotary encoder 24 communicates via protocols, such as SSI and CANopen to the PLC for real time adjustments. The system illustrated in FIG. 9 avoids cumulative errors that occur with incremental encoders and that lose position after power cycles. Thus, the absolute rotary encoder 24 is critical for repeatable accuracy in high-density storage systems. As the shuttle 10 moves, the rotary encoder 24 measures the distance traveled by the shuttle 10 based on the number of rotations of the wheels. The final distance value can take into account the drive chain 20 and the gearbox 22 ratio.

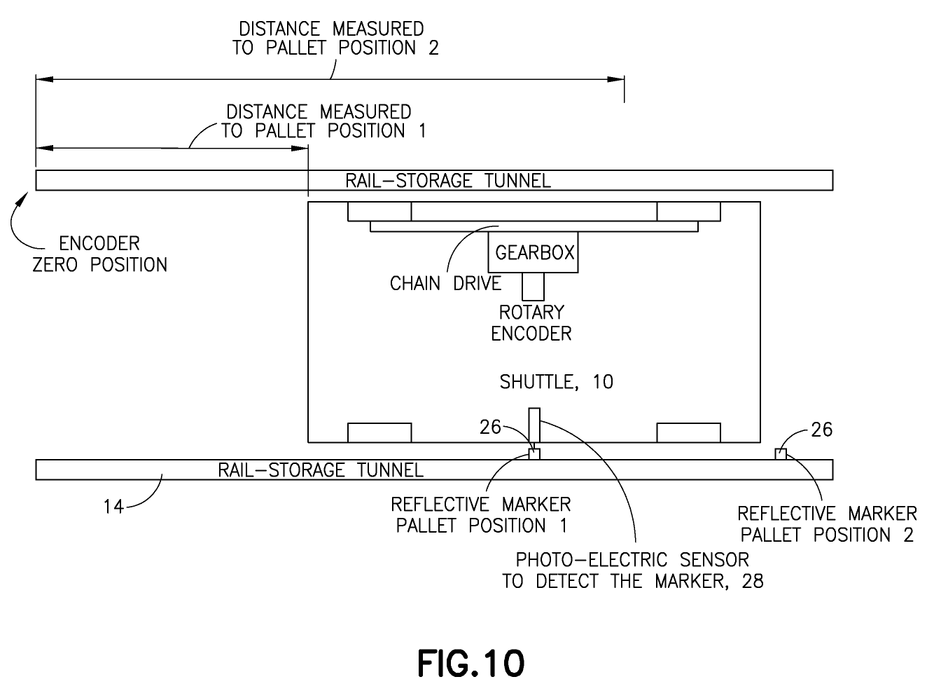

FIG. 10 is similar to FIG. 9 but also includes a reflective marker 26 on the rail 14 and a photosensitive sensor 28 on the shuttle 10. This combination is useful to indicate where the pallet positions are located. The shuttle 10 can use the absolute encoder to calculate the distance to each marker for accurate pallet placement.

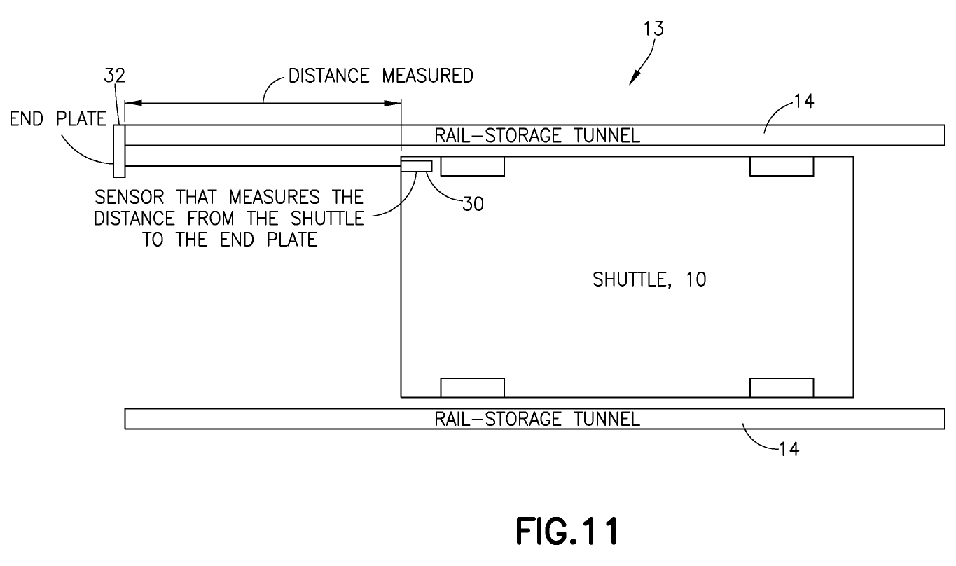

FIG. 11 uses a time-of-flight (ToF) laser apparatus 30 for emitting pulsed light to measure distance to an end plate 32 along the rails 14 of the storage tunnel and thereby providing precise measurement of the distance between the end of the rail or storage tunnel to the location of the shuttle 10. This precise distance can be helpful and necessary for ensuring that the shuttle does not block a space in the rack system of the warehouse for delivering water or a fire-retardant fluid, as required by most fire codes.

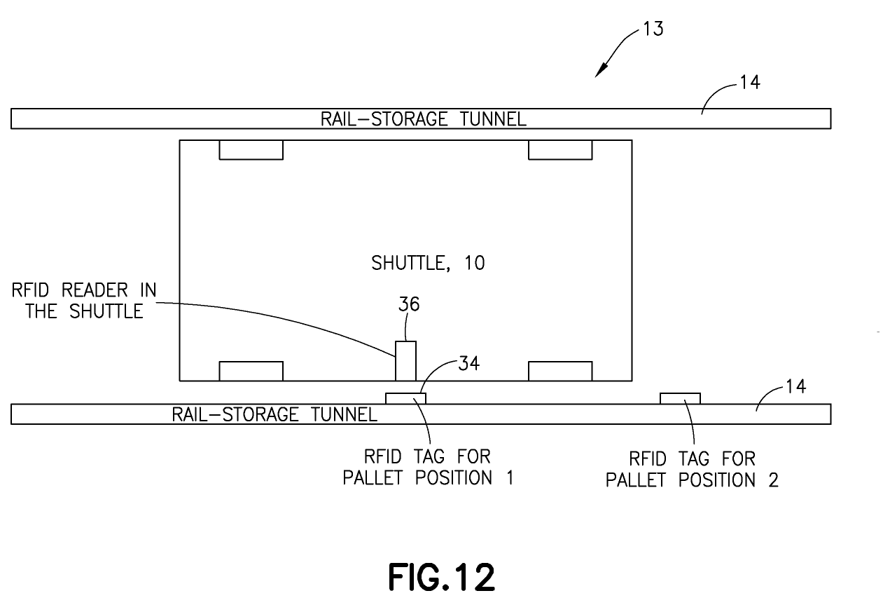

FIG. 12 shows an embodiment where passive RFID tags 34 are mounted on the rail 14 in the storage tunnel and an RFID reader 36 is mounted on the shuttle 10 to determine the exact location of the shuttle 10 along the rails 14 in a particular storage tunnel 13.

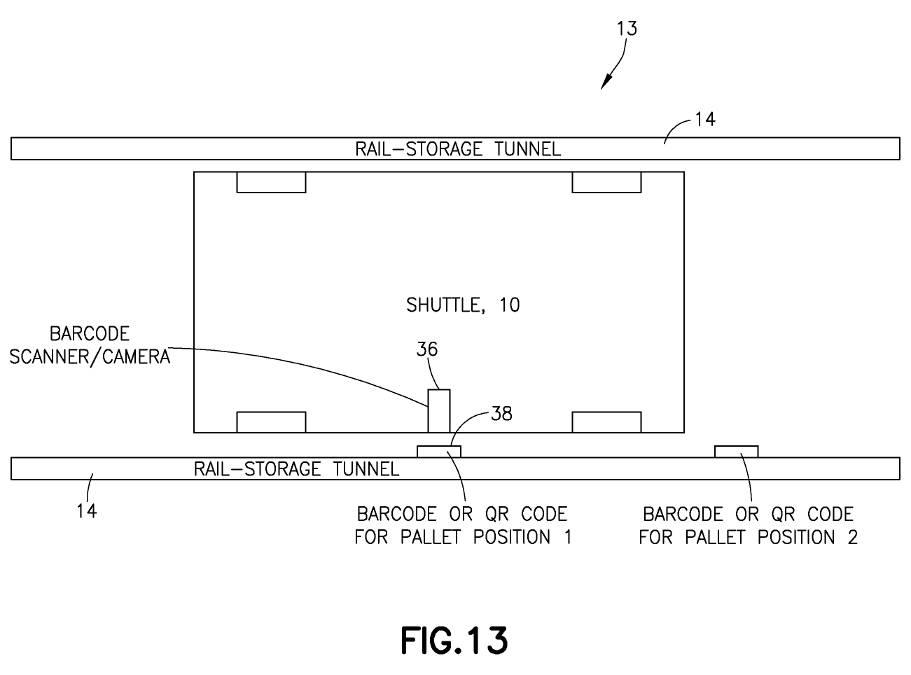

FIG. 13 is similar to FIG. 12 but shows the use of barcodes or QR codes 38 for determining the position of the shuttle or pallet along the rails 14.

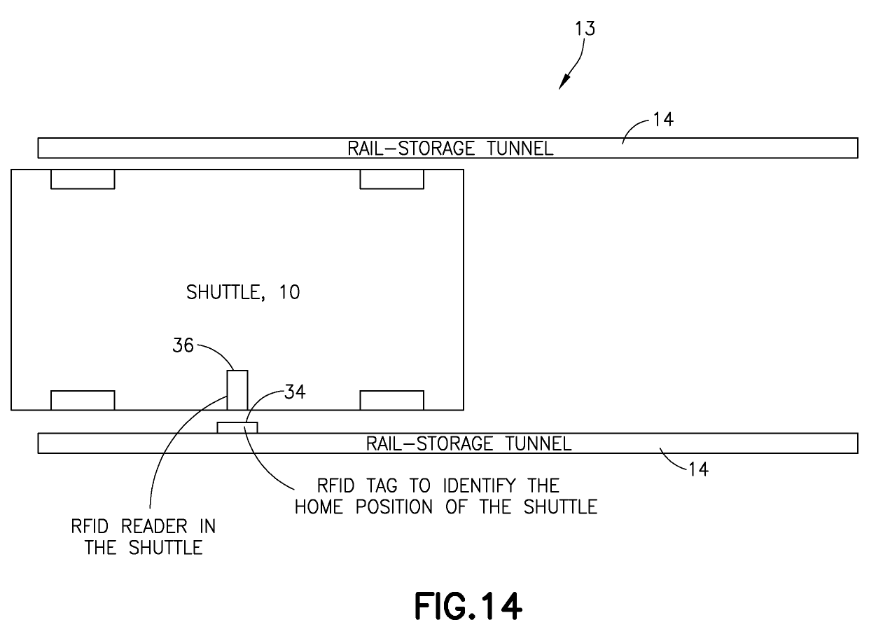

FIG. 14 is similar to FIG. 12 but shows RFID tags 34 along the rail 14 and an RFID reader 36 on the shuttle 10 for determining the home position of the shuttle 10 relative to the rails.

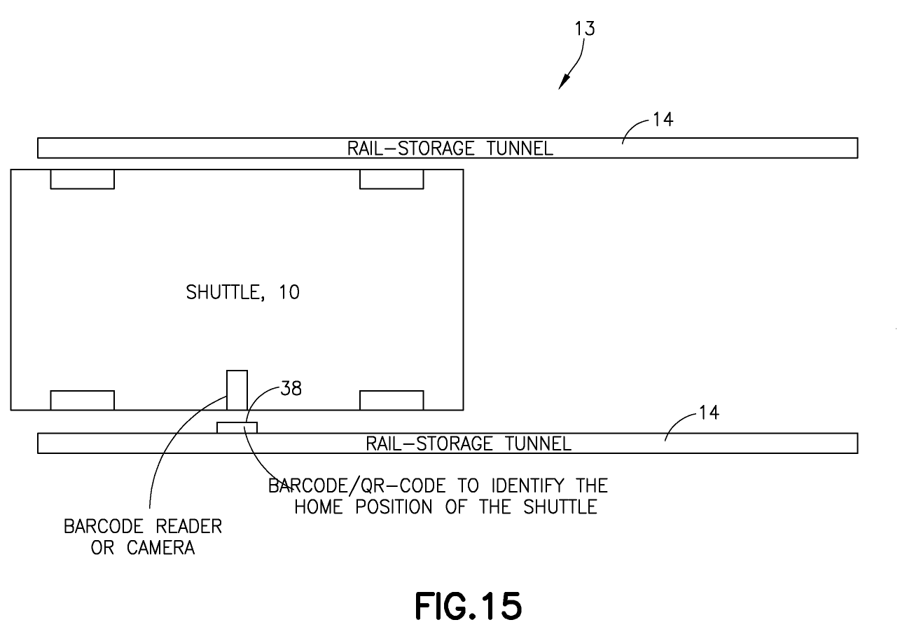

FIG. 15 is similar to FIG. 14 shows the use of barcodes or QR codes 38 for determining the home position of the shuttle 10 relative to the rails 14.

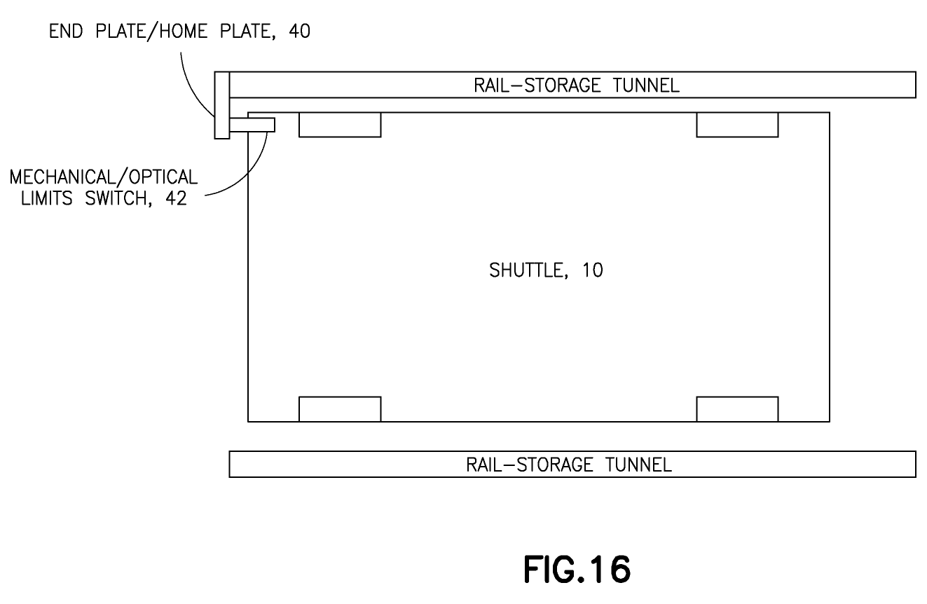

FIG. 16 shows the use of an end plate or home plate 40 in combination with a mechanical or optical limit switch 42 on the shuttle 10 to determine the home position of the shuttle 10 in the storage tunnel 13.

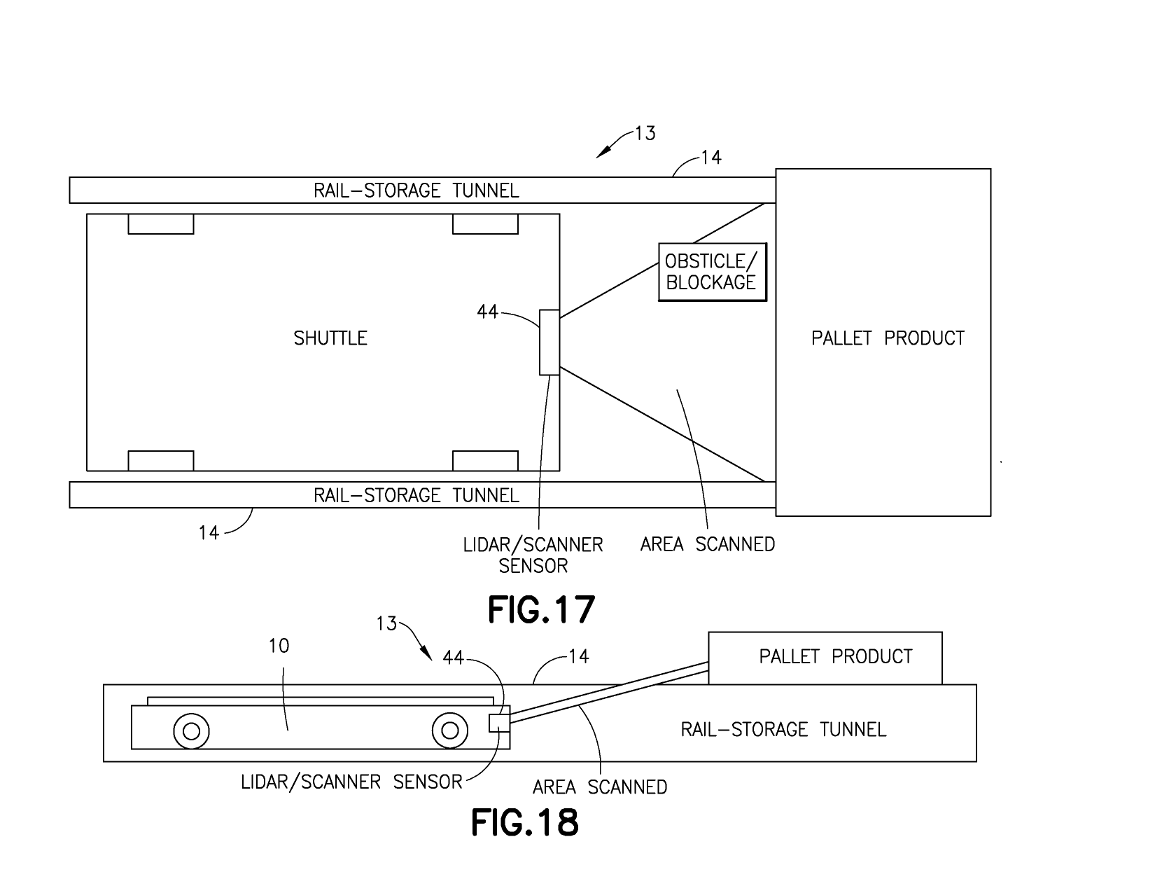

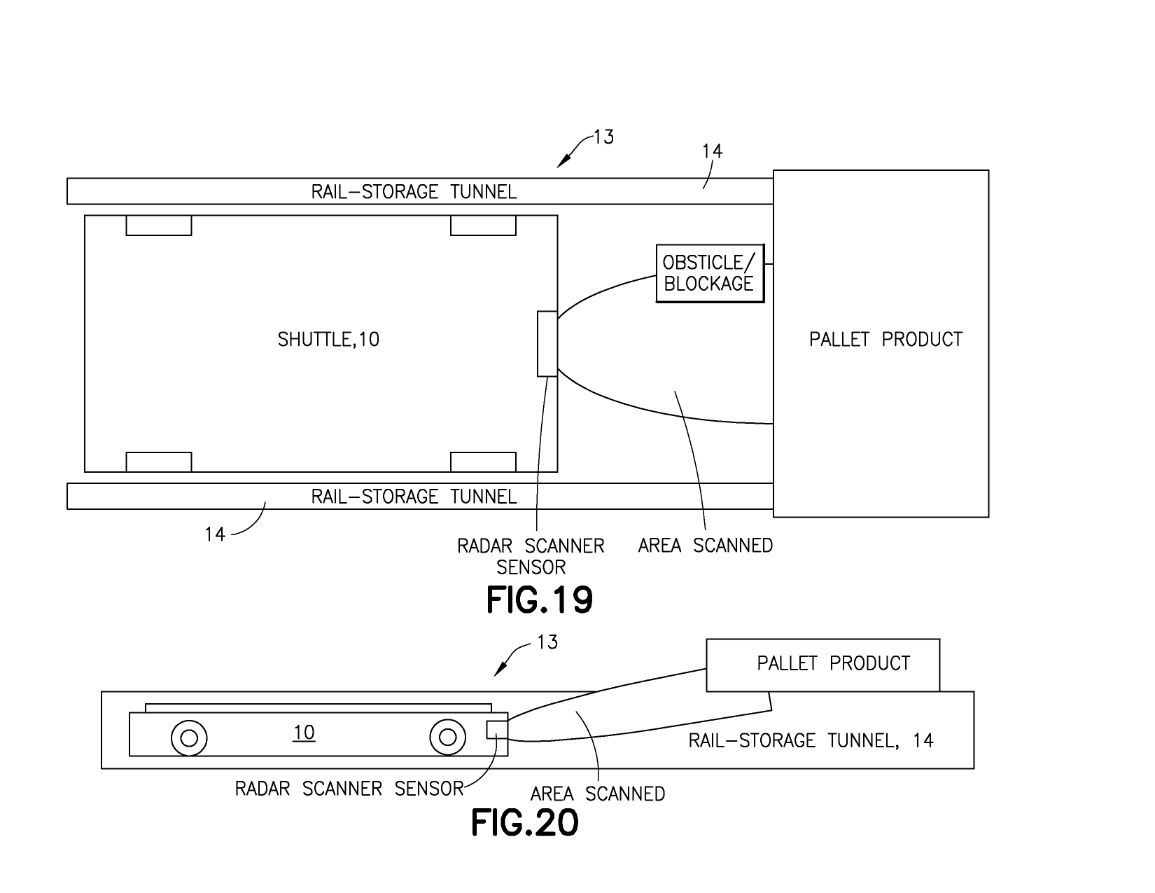

FIGS. 17 and 18 show the use of a LiDAR sensor 44 for collision avoidance purposes. In this regard, the LiDAR sensor 44 can identify a stray object or pallet that may be on the rails. The LiDAR sensor 44 will generate a brake signal that will stop the shuttle 10 before impact.

FIGS. 15 and 16 are similar to FIGS. 13 and 14 but show the use of a radar sensor for collision avoidance purposes.

What is claimed is:

1. A shuttle that is fixedly engageable on forks of a forklift vehicle and that is moveable along a tunnel of a storage rack to move a pallet along the tunnel, comprising:
at least one magnet mounted in a position on the shuttle to align with and magnetically engage at least one of the forks of the fork lift vehicle for releasably holding the shuttle on the forks of the forklift vehicle; and
means for releasing magnetic engagement of the magnet with the at least one fork of the forklift vehicle when the forklift vehicle has positioned the shuttle to move along the tunnel.

2. The shuttle of claim 1, wherein the magnet is an electromagnet, and the shuttle further comprising:
a battery;
a sensor disposed to sense proximity of the shuttle to the storage rack;
a switch disposed to connect the battery to the at least one electromagnet when the sensor senses that the shuttle has exceeded a predetermined proximity of the shuttle to the storage rack and thereby magnetically holding the shuttle on the at least one fork of the forklift vehicle.

3. The shuttle of claim 2, wherein the sensor is in proximity to an end of the shuttle facing the forklift vehicle and is operative to sense when the sensor has moved beyond an entrance to the tunnel.

4. The shuttle of claim 2, wherein the sensor is disposed to sense when the shuttle has been lifted a specified amount relative to the tunnel.

5. The shuttle of claim 1, wherein the magnet is a permanent magnet that is moveably mounted on the shuttle, and the shuttle further comprising a lever to move the permanent magnet sufficiently away from the at least one fork of the forklift vehicle to release the magnetic engagement of the magnet with the at least one fork of the forklift vehicle.

6. The shuttle of claim 1, wherein the magnet is a permanent magnet that is moveably mounted on the shuttle, and the shuttle further comprising a hydraulic switch to move the permanent magnet sufficiently away from the at least one fork of the forklift vehicle to release the magnetic engagement of the magnet with the at least one fork of the forklift vehicle.

7. A position monitoring system for monitoring positions of a pallet shuttle along a tunnel of a storage rack, comprising:
at least one positioning benchmark mounted to at least one position along the tunnel; and
a position determining apparatus mounted on the pallet shuttle for determining a position of the pallet shuttle relative to the at least one positioning benchmark.

8. The position monitoring system of claim 7, wherein the pallet shuttle further comprises:
an electric motor having a rotatable component; and
a control unit for controlling the electric motor, and wherein
the position determining apparatus comprises a rotary encoder that is rotatably driven by the rotatable component of the electric motor; and
the control unit determines the position of the pallet shuttle relative to the positioning benchmark based on rotation of the rotary encoder.

9. The position monitoring system of claim 7, wherein the at least one positioning benchmark comprises reflective markers at specified positions along the tunnel and wherein the position determining apparatus of the pallet shuttle comprises a photoelectric sensor to identify the reflective markers and an absolute encoder for calculating a position of the pallet shuttle along the tunnel based on light reflected from the reflective markers and detected by the photoelectric sensor.

10. The position monitoring system of claim 7, wherein the at least one positioning benchmark comprises an end plate projecting into the tunnel from the storage rack and the pallet shuttle further comprises a time-of-flight laser apparatus for emitting pulsed light toward the end plate and determining a position of the pallet shuttle based on a time for receiving the light reflected from the end plate.

11. The position monitoring system of claim 7. further comprising passive RFID tags mounted at specified positions in the tunnel and an RFID tag reader mounted on the pallet shuttle.

12. The position monitoring system of claim 7. further comprising passive bar codes disposed at specified positions in the tunnel and a camera or scanner mounted on the pallet shuttle.

13. A monitoring system for monitoring movement of a pallet shuttle along a tunnel of a storage rack, comprising:
a motor for moving the pallet shuttle along the tunnel in at least one moving direction;
at least one sensor mounted at least to a front end of the pallet shuttle for identifying an obstacle in front of the pallet shuttle and generating a stop signal for stopping the motor in response to identification of the obstacle.
